(19) United States
(12) Patent Application Publication
(10) Pub. No.: US 2010/0097955 A1
(43) Pub. Date: Apr. 22, 2010

(54) RATE DETERMINATION

(75) Inventor: Yu-Cheun Jou, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/252,544

(22) Filed: Oct. 16, 2008

(51) Int. Cl. H04L 12/26

(52) U.S. Cl. 370/253

(57) ABSTRACT

Techniques for performing low-latency blind rate detection of a frame, wherein the frame is divided into a plurality of sub-segments. In an exemplary embodiment, symbols of a primary sub-segment of a frame are received and deinterleaved to recover information bits and at least one quality metric for each of a plurality of rate hypotheses. Symbols of a secondary sub-segment of the frame are also received and deinterleaved to recover information bits and at least one quality metric for each of the plurality of rate hypotheses. The recovered information bits and quality metrics for each rate hypothesis may be compared between the primary and secondary sub-segments to select the most likely rate hypothesis. In an exemplary embodiment, the at least one quality metric may include a frame quality indicator (FQI) such as a cyclical redundancy check (CRC).

### TECHNICAL FIELD

The present invention relates generally to data communication, and more specifically to techniques for detecting received messages when a signaling rate of the messages is not known a priori.

### BACKGROUND

Wireless communication systems are widely deployed to provide various types of communication such as voice, packet data, and so on. These systems may be based on code division multiple access (CDMA), time division multiple access (TDMA), frequency division multiple access (FDMA), or other multiple access techniques.

For enhanced flexibility and better utilization of the available system capacity, some communication systems transmit data using a signaling scheme that supports a number of different data rates or transport formats. For example, in a cdma-2000 system, data may be transmitted at one of four possible rates (i.e., full, half, quarter, and eight rates), with the rate being selected for each frame based on the amount of data to be transmitted. In particular, data may be sent using full rate during periods of active speech and eighth rate during periods of silence (e.g., pauses). In a W-CDMA system, data may be transmitted using one of a number of supported transport formats, again depending on the amount of data to be transmitted.

To minimize overhead, no signaling may be sent to indicate the particular rate or transport format being used for a particular frame. In this case, the receiver needs to perform “blind rate detection” of each received frame to determine the rate associated with each frame. In prior art blind rate detection schemes, a receiver chooses a most likely candidate rate or transport format used for a particular frame based on the symbols received for that frame. Such prior art schemes usually require the receiver to wait until all symbols of a frame have been received, before choosing the most likely candidate rate or transport format.

In certain applications, the receiver may be required to decode and make available the symbols of a frame prior to all symbols of the frame being received. In these applications, it would be desirable to provide blind rate detection techniques that can choose the most likely candidate rate or transport format for a frame, and/or decode the already received symbols, prior to all symbols of the frame being received.

### SUMMARY

An aspect of the present disclosure provides a method for performing blind rate detection of a frame, the frame comprising a plurality of sub-segments, the method comprising: deinterleaving symbols of a primary sub-segment of the frame; for each of a plurality of rate hypotheses, recovering information bits based on symbols comprising the deinterleaved symbols of the primary sub-segment; for each of the plurality of rate hypotheses, generating at least one quality metric based on symbols comprising the deinterleaved symbols of the primary sub-segment; deinterleaving symbols of a secondary sub-segment of the frame; for each of the plurality of rate hypotheses, recovering information bits based on symbols comprising the deinterleaved symbols of the secondary sub-segment; for each of the plurality of rate hypotheses, generating at least one quality metric based on symbols comprising the deinterleaved symbols of the secondary sub-segment; and based on the recovered information bits and quality metrics for the primary and secondary sub-segments, selecting a candidate rate hypothesis using a rate detection algorithm.

Another aspect of the present disclosure provides an apparatus for performing blind rate detection of a frame, the frame comprising a plurality of sub-segments, the apparatus comprising: a deinterleaver configured to deinterleave symbols of a primary sub-segment and a secondary sub-segment of the frame; a decoding module configured to, for each of a plurality of rate hypotheses, recover information bits based on symbols comprising the deinterleaved symbols of the primary sub-segment, and to recover information bits based on symbols comprising the deinterleaved symbols of the secondary sub-segment; a quality metric generator configured to, for each of a plurality of rate hypotheses, generate at least one quality metric based on symbols comprising the deinterleaved symbols of the primary sub-segment, and to generate at least one quality metric based on symbols comprising the deinterleaved symbols of the secondary sub-segment; and a rate detection module configured to, based on the recovered information bits and quality metrics for the primary and secondary sub-segments, select a candidate rate hypothesis using a rate detection algorithm.

Yet another aspect of the present disclosure provides an apparatus for performing blind rate detection of a frame, the frame comprising a plurality of sub-segments, the apparatus comprising: means for deinterleaving symbols of a primary sub-segment and a secondary sub-segment of the frame; means for recovering information bits based on symbols comprising the deinterleaved symbols of the primary sub-segment, and based on symbols comprising the deinterleaved symbols of the secondary sub-segment, for each of a plurality of rate hypotheses; means for generating at least one quality metric based on symbols comprising the deinterleaved symbols of the primary sub-segment, and based on symbols comprising the deinterleaved symbols of the secondary sub-segment, for each of the plurality of rate hypotheses; and means for selecting a candidate rate hypothesis using a rate detection algorithm.

Yet another aspect of the present disclosure provides a computer program product for performing blind rate detection of a frame, the frame comprising a plurality of sub-segments, the product comprising: computer-readable medium comprising: code for causing a computer to deinterleave symbols of a primary sub-segment and a secondary sub-segment of the frame; code for causing a computer to recover information bits based on symbols comprising the deinterleaved symbols of the primary sub-segment, and based on symbols comprising the deinterleaved symbols of the secondary sub-segment, for each of a plurality of rate hypotheses; code for causing a computer to generate at least one quality metric based on symbols comprising the deinterleaved symbols of the primary sub-segment, and based on symbols comprising the deinterleaved symbols of the secondary sub-segment, for each of the plurality of rate hypotheses; and code for causing a computer to select a candidate rate hypothesis using a rate detection algorithm.

### BRIEF DESCRIPTION OF DRAWINGS

FIGS. 1 and 1A depict a prior art frame processing scheme for processing information bits at a transmitter.

FIGS. 2A and 2B depict specific frame processing schemes according to the W-CDMA and cdma-2000 standards, respectively.

FIG. 3 illustrates a prior art method for recovering estimated information bits b′ from received symbols y, given that the rate R is known a priori.

FIG. 3A illustrates a prior art blind rate detection method for recovering estimated information bits b′ and an estimated rate R′ from received symbols y, given that the signaling rate R is not known a priori.

FIG. 4 depicts a blind rate detection method according to the present disclosure for accommodating such applications.

FIG. 5 depicts an exemplary embodiment of a rate detection algorithm according to the present disclosure.

FIG. 5A depicts an alternative exemplary embodiment of a rate detection algorithm that utilizes alternative rate decision metrics.

FIG. 6 depicts an alternative exemplary embodiment of a low-latency blind rate detection method according to the present disclosure.

### DETAILED DESCRIPTION

The detailed description set forth below in connection with the appended drawings is intended as a description of exemplary embodiments of the present invention and is not intended to represent the only exemplary embodiments in which the present invention can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. It will be apparent to those skilled in the art that the exemplary embodiments of the invention may be practiced without these specific details. In some instances, well known structures and devices are shown in block diagram form in order to avoid obscuring the novelty of the exemplary embodiments presented herein.

In this specification and in the claims, it will be understood that when an element is referred to as being “connected to” or “coupled to” another element, it can be directly connected or coupled to the other element or intervening elements may be present. In contrast, when an element is referred to as being “directly connected to” or “directly coupled to” another element, there are no intervening elements present.

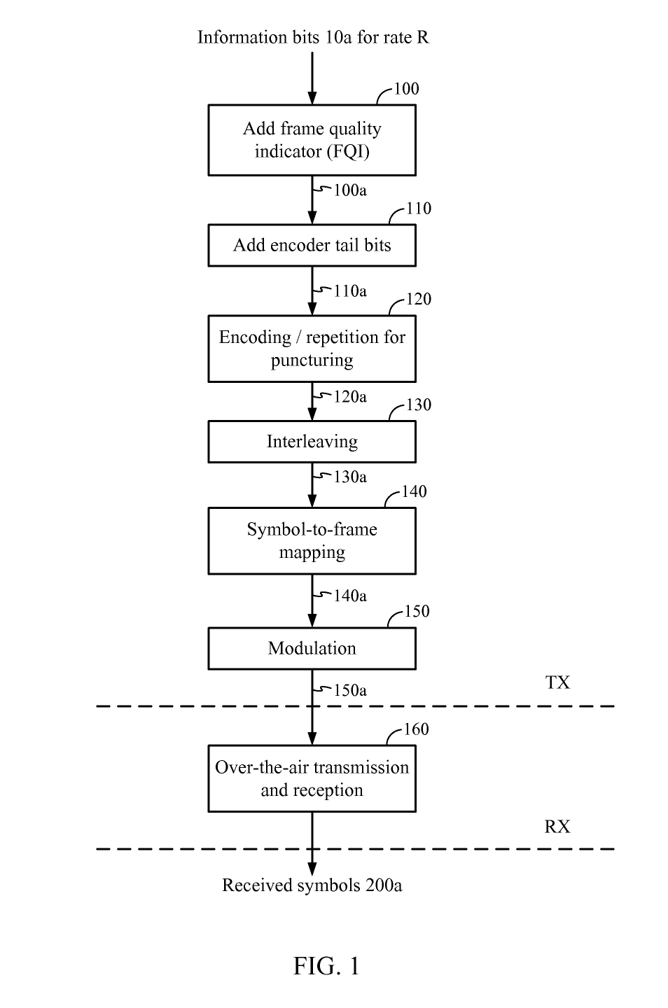

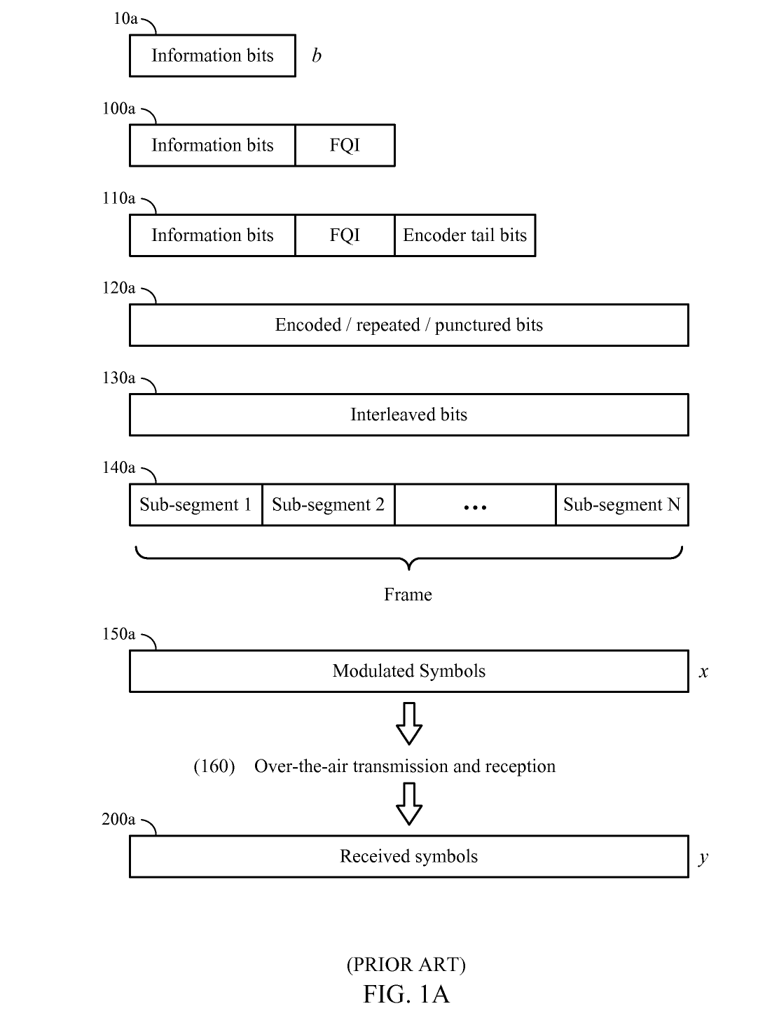

FIG. 1 depicts a prior art frame processing scheme for processing information bits 10a at a transmitter. FIG. 1A depicts the status of the data processed by the operations depicted in FIG. 1.

Note the frame processing scheme is shown for illustrative purposes only, and is not meant to restrict the scope of the present disclosure to any particular processing scheme shown. Alternative exemplary embodiments of the present disclosure may adopt alternative frame processing schemes which may, e.g., re-order the steps of the scheme shown in FIG. 1, and/or add steps to or delete steps from the scheme shown. Such alternative exemplary embodiments are contemplated to be within the scope of the present disclosure.

In FIG. 1, an information source generates information bits 10a at a selected rate R. The number of information bits 10a generated per frame may depend on the selected rate R. For example, in a cdma2000 system, there may be 172 information bits per 20-millisecond frame (“full rate”), 80 bits per frame (“half rate”), 40 bits per frame (“quarter rate”), or 16 bits per frame (“eighth rate”). The information bits 10a for a frame are collectively denoted by the variable b in FIG. 1A.

At step 100, a frame-quality indicator (FQI) may be generated and appended to the information bits 10a for a frame. For example, an FQI may be a cyclical-redundancy check (CRC) known to one of ordinary skill in the art. Signal 100a represents the combination of the information bits 10a and the FQI, as also depicted in FIG. 1A.

At step 110, encoder tail bits may be added to the signal 100a. For example, encoder tail bits may represent a fixed number of zero-valued tail bits for a convolutional encoder. Signal 110a represents the combination of signal 100a with the encoder tail bits, as also depicted in FIG. 1A.

At step 120, the signal 110a is encoded and repeated (or punctured). As earlier described, the encoding may include convolutional encoding, and the repetition may serve to further increase (or decrease, in the case of puncturing) the transmitted energy associated with each symbol. Note the encoding may employ other techniques known to one of ordinary skill in the art, such as block encoding or other types of encoding, and need not be limited to the encoding explicitly described in the present disclosure. The signal 120a represents the encoded and repeated (or punctured) version of signal 110a, as also depicted in FIG. 1A.

At step 130, the signal 120a is interleaved, e.g., to improve the diversity of the encoded symbols along a chosen signal dimension. In an exemplary implementation, the symbols may be interleaved over time. Signal 130a represents the interleaved version of signal 120a, as also depicted in FIG. 1A.

At step 140, the interleaved symbols of signal 130a are mapped to a pre-defined frame format, as also depicted in FIG. 1A. A frame format may specify the frame as being composed of a plurality of sub-segments. In an exemplary embodiment, sub-segments may be any portions of the frame contiguous along a given dimension, e.g., time, frequency, code, or any other dimension. A frame may be composed of a fixed plurality of such sub-segments, each sub-segment containing a portion of the total number of symbols allocated to the frame. For example, in an exemplary embodiment according to the W-CDMA standard, a sub-segment may be defined as a slot. In an exemplary embodiment according to the cdma-2000 standard, a sub-segment may be defined as a power control group (PCG).

In certain exemplary embodiments, the interleaved symbols may be mapped in time, frequency, code, or any other dimensions used for signal transmission. Furthermore, a frame format may also specify the inclusion of, e.g., control symbols (not shown) along with the interleaved symbols of signal 130a. Such control symbols may include, e.g., power control symbols, frame format information symbols, etc. Signal 140a represents the output of the symbol-to-frame mapping step 140, as also depicted in FIG. 1A.

At step 150, the signal 140a is modulated, e.g., onto one or more carrier waveforms. In certain exemplary embodiments, the modulation may employ, e.g., QAM (quadrature amplitude modulation), QPSK (quadrature phase-shift keying), etc. Signal 150a represents the modulated version of the signal 140a, as also depicted in FIG. 1A. Signal 150a is further denoted by the variable x in FIG. 1A.

At step 160, the modulated signal 150a is further processed, transmitted over the air, and received by a receiver. Step 160 generates the received symbols 200a, further denoted by the variable y in FIG. 1A. Note one of ordinary skill in the art will appreciate that the techniques for processing the signal 150a for transmission and reception over-the-air are well-known, and are not further disclosed herein. The symbols contained in y may be further processed as described hereinbelow.

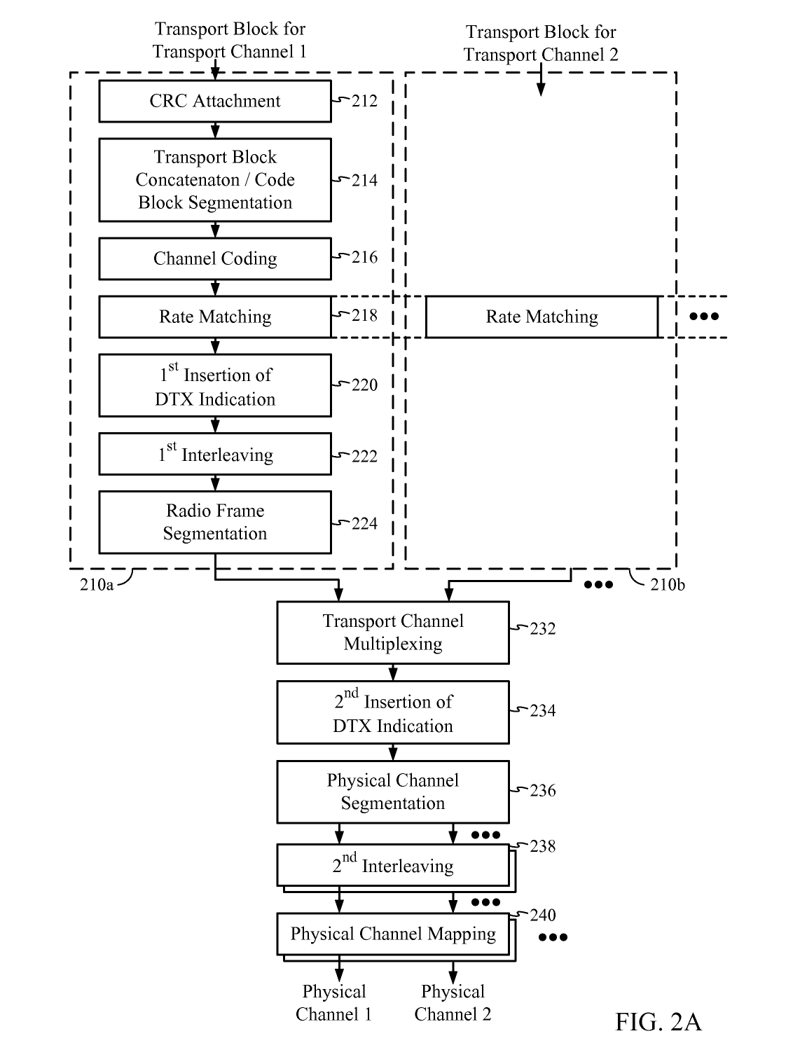

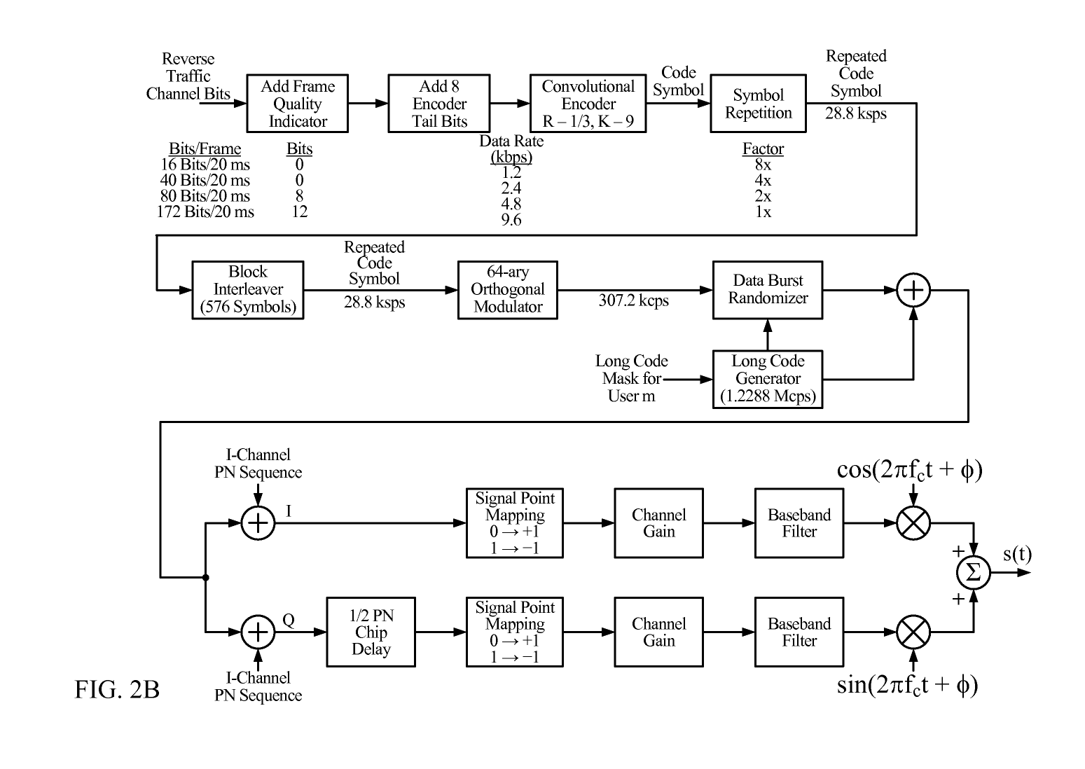

FIGS. 2A and 2B depict specific frame processing schemes according to the W-CDMA and cdma-2000 standards, respectively. The operations depicted in FIGS. 2A and 2B are well-known to one of ordinary skill in the art, and will not be described further herein. One of ordinary skill in the art will appreciate that the techniques of the present disclosure, described hereinbelow with reference to the exemplary embodiment of FIG. 1, may readily be applied to systems designed for the standards depicted in FIGS. 2A and 2B, as well as to standards not explicitly depicted herein. Note the specific frame processing schemes shown in FIGS. 2A and 2B are given for illustrative purposes only, and are not meant to restrict the scope of the present disclosure to exemplary embodiments designed for W-CDMA or cdma-2000. Exemplary embodiments designed for other standards not mentioned are also contemplated to be within the scope of the present disclosure.

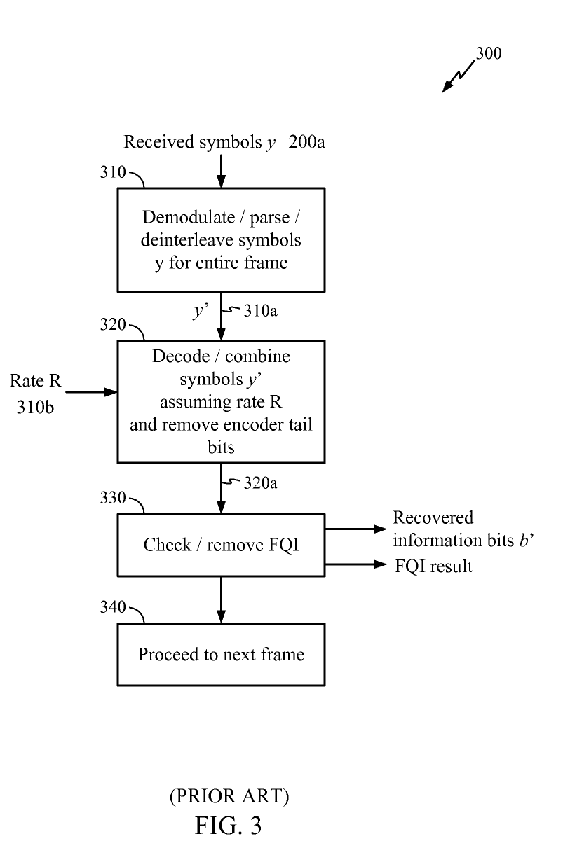

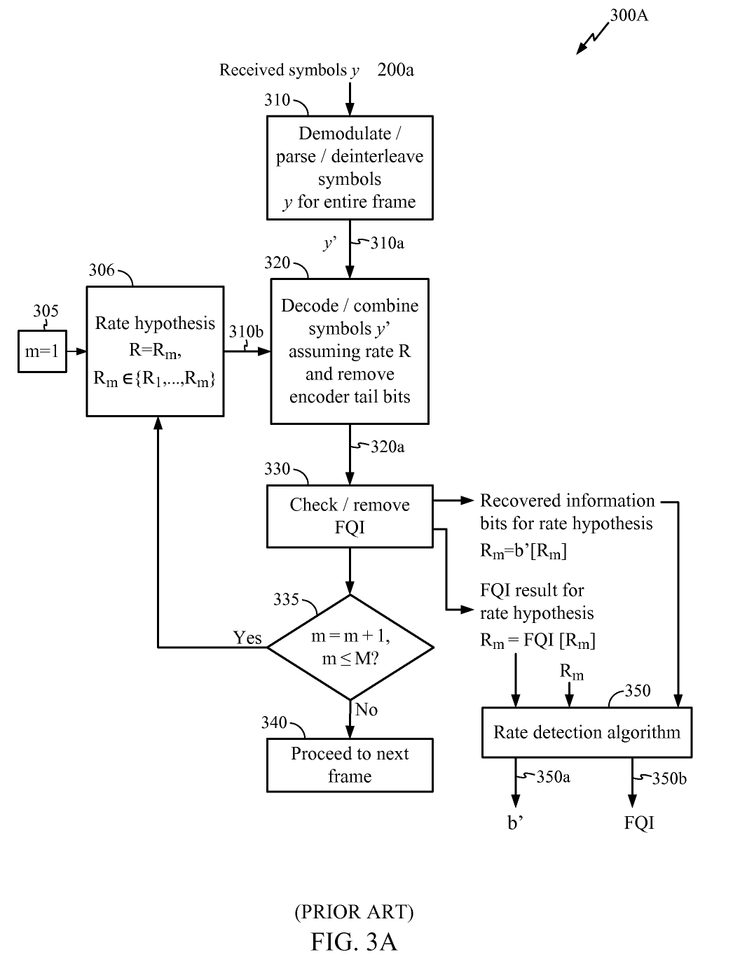

FIG. 3 illustrates a prior art method 300 for recovering estimated information bits b′ from received symbols y, given that the rate R is known a priori. In an implementation, the rate R may be agreed upon by transmitter and receiver through separate messaging, or it may be signaled from transmitter to receiver for each frame. Note FIG. 3 is provided for illustrative purposes only, and is not meant to limit the scope of the present disclosure.

At step 310, received symbols y or 200a are received for an entire frame, and subsequently demodulated, parsed, and deinterleaved to produce symbols y′, also denoted as signal 310a. One of ordinary skill in the art will appreciate that the operations performed at step 310 may correspond to the inverse of the corresponding operations performed at the transmitter, as shown in, e.g., steps 150, 140, and 130 of FIG. 1.

At step 320, the symbols y′ are decoded and combined, given knowledge of the rate R, also denoted as signal 310b. Tail bits of the decoded sequence, e.g., as appended at step 110 of FIG. 1, may also be removed at step 320. In an implementation, the rate R may indicate how many bits are present in a received frame, and may be used, e.g., by the decoder to determine at which point in the received symbol sequence to terminate decoding, and/or remove tail bits from the decoded sequence. The result of step 320 is an output signal 320a.

At step 330, the FQI, e.g., as appended at step 100 of FIG. 1, is checked, and also removed from the information bits. In an implementation, the result of the FQI check may identify the rate detection as either a success (corresponding herein to a logical “1”) or a failure (corresponding herein to a logical “0”). One of ordinary skill in the art will appreciate that by checking the FQI result at step 330, the receiver may also determine whether decoded bits contain errors. Step 330 generates the recovered information bits, denoted as b′, along with the FQI result, which may indicate either a success or failure.

At step 340, the method may proceed to repeat the steps described above for the subsequent frame.

FIG. 3A illustrates a prior art blind rate detection method 300A for recovering estimated information bits b′ and an estimated rate R′ from received symbols y, given that the signaling rate R is not known a priori. Note the method of FIG. 3A is provided for illustrative purposes only, and is not meant to restrict the scope of the present disclosure to any particular techniques explicitly disclosed.

In FIG. 3A, the method commences at step 310, and proceeds to step 320, similar to method 300 of FIG. 3. At step 320, the method uses an initial rate hypothesis R=Rm as supplied by step 306, wherein m is an index to the total number M of possible rates used by the transmitter, and m is initialized to m=1 at step 305.

At step 330, the method generates recovered information bits b′[Rm] for the rate hypothesis Rm, along with the FQI result FQI[Rm] for the rate hypothesis Rm. b′[Rm] and FQI[Rm] are provided, along with Rm, to a rate detection algorithm 350. The rate detection algorithm 350 may store the recovered information bits b′[Rm] and FQI result FQI[Rm] for a given rate hypothesis Rm, to be subsequently compared with recovered bits and FQI results for alternative rate hypotheses.

At step 335, the method increments the index m, and determines whether there are additional rate hypotheses to be tested. If so, the method proceeds to step 306, and updates R with the value Rm of the next rate hypothesis. The method re-executes steps 320 and 330 to generate new recovered information bits b′[Rm] and FQI result FQI[Rm] for the new rate hypothesis Rm, which again are provided to the rate detection algorithm 350.

When all rate hypotheses have been evaluated, as determined at step 335, the method proceeds to the next frame at step 340.

After recovered information bits b′[Rm] and FQI results FQI[Rm] for all rate hypotheses Rm have been generated and provided to the rate detection algorithm 350, the rate detection algorithm 350 may select a most likely rate hypothesis R′ (or signal 350a), along with recovered bits b′ (or signal 350b) corresponding thereto, for the received frame. The rate detection algorithm 350 may also provide additional information not shown, e.g., an indication of whether rate detection was successful.

One of ordinary skill in the art will appreciate that various prior art rate detection algorithms exist, and the techniques of the present disclosure are not intended to be restricted to any particular implementation of a rate detection algorithm. For example, in one implementation, a rate detection algorithm may utilize the FQI results corresponding to the multiple rate hypotheses, and declare the detected rate to be a rate hypothesis with the correct FQI result (i.e., positive frame quality indication). One of ordinary skill will also appreciate that other metrics may also be incorporated in the rate detection algorithm, e.g., a zero-state metric and/or energy metric of the decoder. It is contemplated that such alternative rate detection techniques may readily be combined with the principles for early rate detection to be disclosed hereinbelow, and that such combinations are within the scope of the present disclosure.

In the prior art blind rate detection method depicted in FIG. 3A, the decoding/rate hypothesis testing steps 320-330 and rate detection algorithm 350 are executed only after receiving all symbols y of a frame at step 310. This generally sets a minimum bound on the decoding latency of the method, e.g., the latency from the time at which the first symbols of the frame are received to the earliest time at which a rate estimate for the frame can be provided. In some low-latency applications, it may be desirable or mandatory to estimate the detected rate and the recovered information bits as the symbols y are being received, without necessarily waiting for all symbols of a frame to be received.

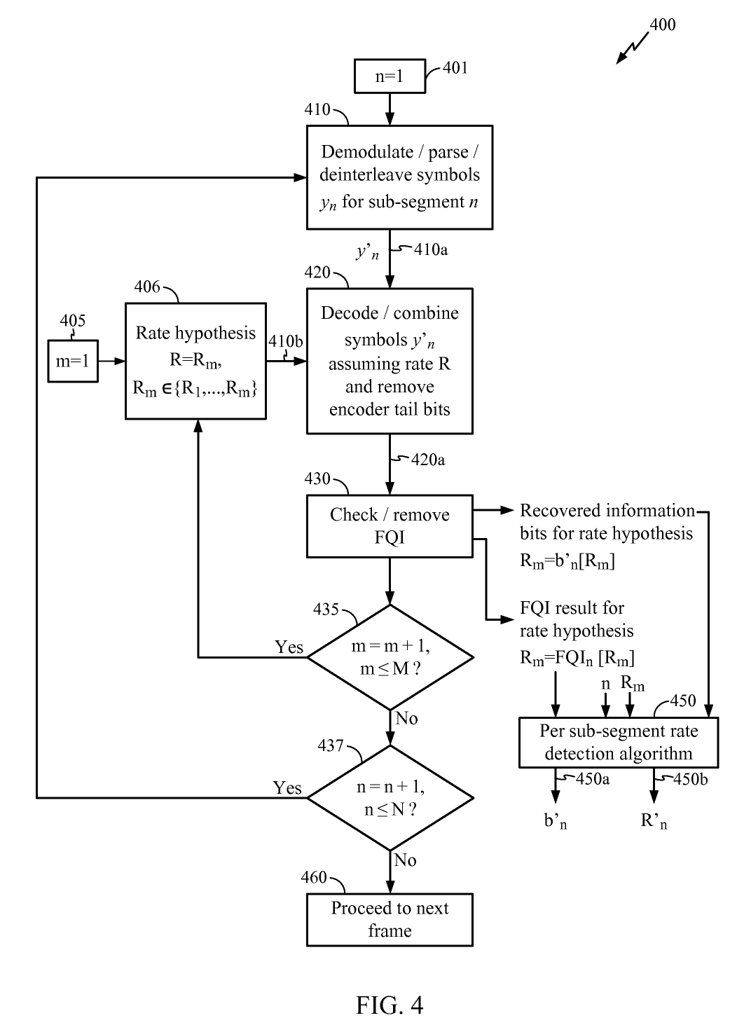

FIG. 4 depicts a blind rate detection method 400 according to the present disclosure for accommodating such low-latency applications. Note the method 400 is shown for illustrative purposes only, and is not intended to restrict the scope of the present disclosure to any particular exemplary embodiments shown.

In FIG. 4, at step 401, a sub-segment index n is initialized to n=1.

At step 410, the method demodulates, parses, and deinterleaves symbols yₙ received for sub-segment n of the current frame, and generates symbols y′ₙ.

At step 420, the method decodes and combines the symbols y′ₙ received for the sub-segment n, assuming a rate R=Rm, wherein m is an index to the plurality M of rate hypotheses, and m is initialized to m=1 at step 405. One of ordinary skill in the art will appreciate that while the symbols y′ₙ represent only a portion of the total number of symbols y′ available for the entire frame, decoding of y′ₙ for the entire frame may nevertheless be executed. This may be due to, e.g., redundancy in the symbols y′ introduced by encoding and/or repetition at step 120 of FIG. 1, and/or time or other-dimensional diversity achieved via interleaving at step 130 of FIG. 1, e.g., interleaving over time.

At step 420, the encoded tail bits may further be removed from the decoded bit sequence to generate the signal 420a associated with sub-segment n.

At step 430, the method checks the FQI from the signal 420a associated with sub-segment n, and generates an FQI result FQIₙ[Rm] corresponding to the rate hypothesis Rm. Also at step 430, the method may recover information bits b′ₙ[Rm]. b′ₙ[Rm] and FQIₙ[Rm] may be supplied to a per-sub-segment rate detection algorithm 450, along with the current values of the variables n and Rm.

At step 435, the method increments m, and determines whether there are additional rate hypotheses to be evaluated. If yes, the method proceeds to step 406, wherein a new rate hypothesis Rm is assigned to R. If no, the method proceeds to step 437.

At step 437, the method increments n, and determines whether there are additional sub-segments left in the frame to be evaluated. If yes, the method returns to step 410. If no, the method proceeds to process the next frame at step 460.

One of ordinary skill in the art will appreciate that the per-sub-segment rate detection algorithm 450 may be configured to generate a detected rate hypothesis R′ₙ and associated recovered bits b′ₙ on a per-sub-segment basis, i.e., as the symbols y′ₙ are received for each sub-segment. This decreases the decoding latency of the method 400 as compared to that of the prior art method 300A.

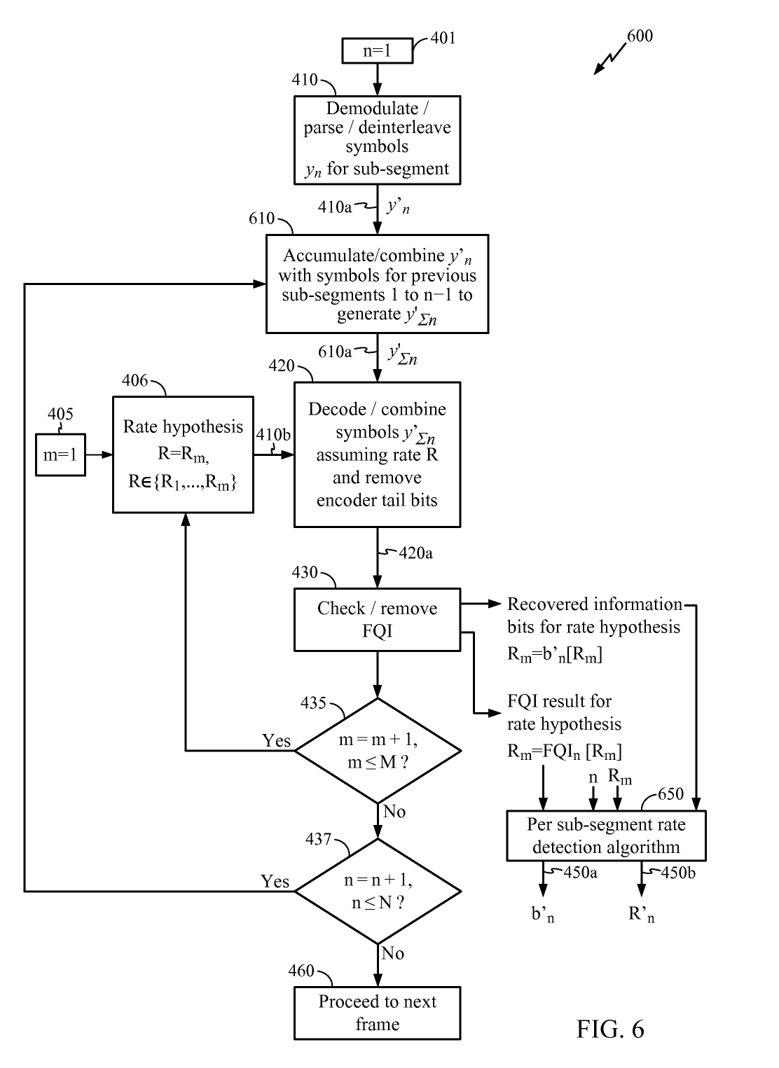

In an exemplary embodiment, the per-sub-segment rate detection algorithm 450 may operate identically to the rate detection algorithm 350 by simply utilizing the recovered information bits b′ₙ[R1] through b′ₙ[RM] and FQI results FQIₙ[R1] through FQIₙ[RM] from the sub-segment n, rather than from the full frame, to perform rate detection at the end of any sub-segment. In an alternative exemplary embodiment, more accurate estimates for the detected rate R′ₙ and information bits b′ₙ may be obtained without sacrificing decoding latency, by combining information from multiple sub-segments of the frame as they are received, as further described with reference to FIG. 6 hereinbelow.

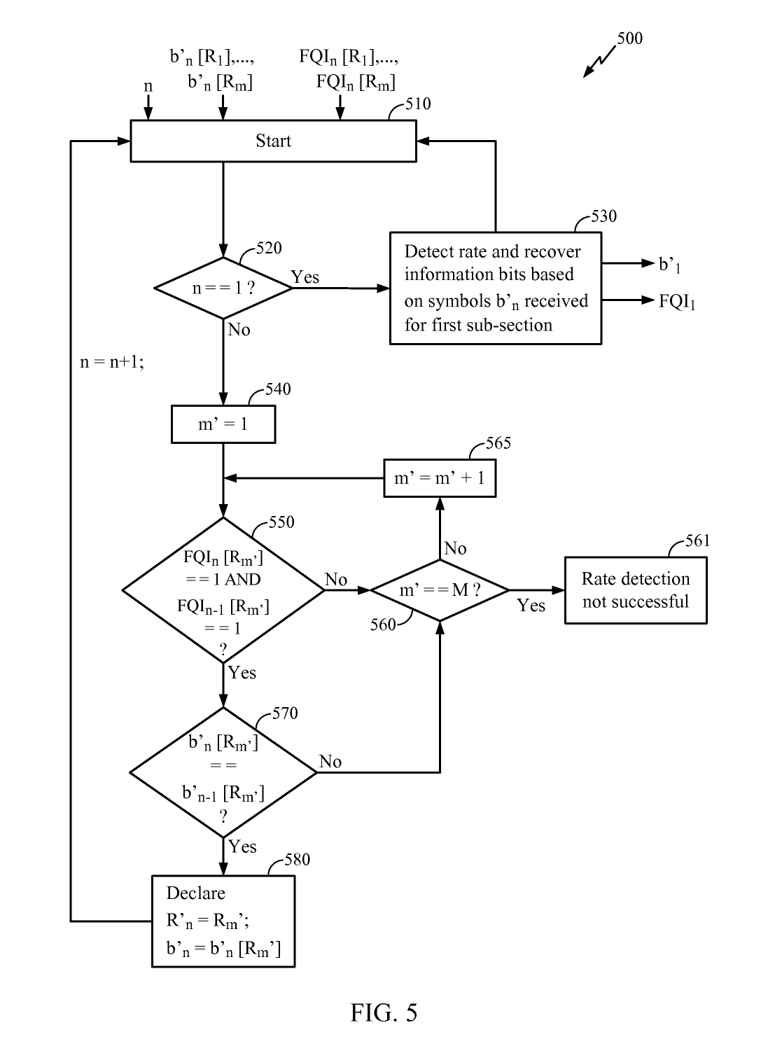

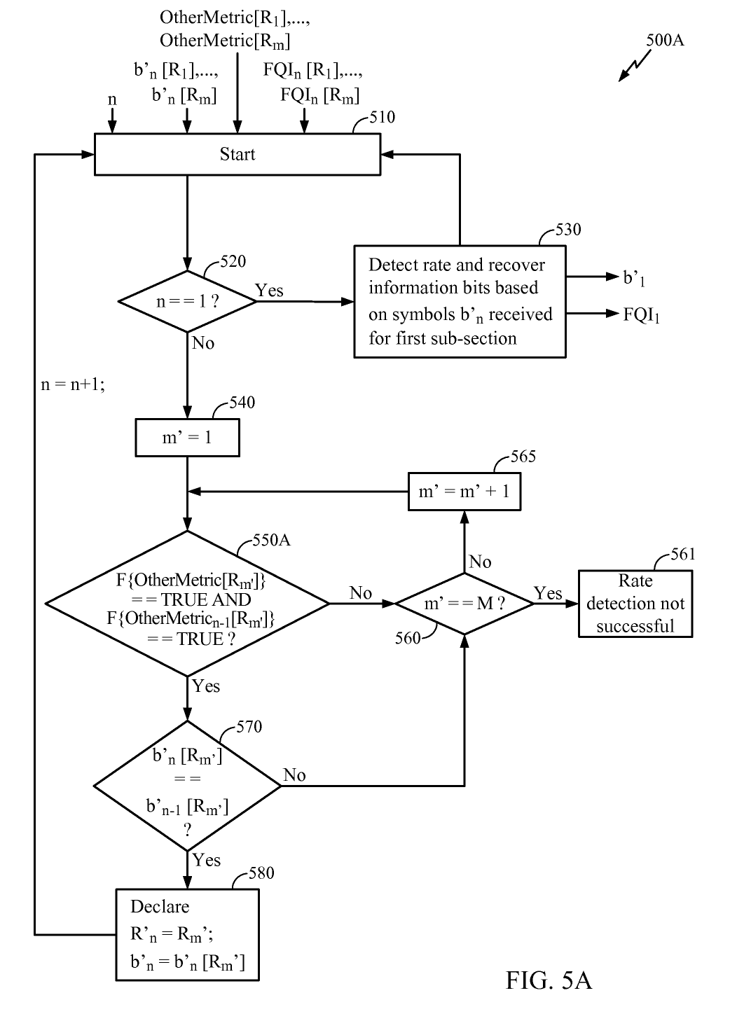

FIG. 5 depicts an exemplary embodiment 500 of a rate detection algorithm according to the present disclosure. Note the algorithm 500 is shown for illustrative purposes only, and is not intended to limit the scope of the present disclosure to any particular rate detection algorithm shown, e.g., rate detection algorithms other than 500 may be employed for the block 450 in method 400 without departing from the scope of the present disclosure.

In FIG. 5, at step 510, the method inputs recovered information bits b′ₙ[R1] through b′ₙ[RM] and FQI results FQIₙ[R1] through FQIₙ[RM], corresponding to each of the plurality of rate hypotheses RI through Rm for sub-segment n. In an exemplary embodiment, the information bits b′ₙ may be recovered from multiple iterations of steps 420 and 430, i.e., one iteration for each rate hypothesis. At step 510, the method may also input the index n corresponding to the current sub-segment being processed.

At step 520, the method checks whether n is equal to 1, i.e., whether the current sub-segment being processed is the first sub-segment of the frame. If yes, the method may proceed to step 530, wherein the recovered information bits b′₁ and rate R′₁ may be determined based solely on the symbols y′₁ received for sub-segment 1, as they are the only symbols available for the current frame. If n is not equal to 1, then the method proceeds to step 540.

At step 540, a rate hypothesis index m′ is initialized to 1.

At step 550, the method verifies whether both the FQI results for sub-segment n and sub-segment n−1 are successes for the tested rate hypothesis m′, i.e., whether FQIₙ[Rm]==1 and FQIₙ₋₁[Rm′]==1. If yes, this may be an indication that the tested rate hypothesis m′ is indeed the correct rate hypothesis for the currently received symbols, and the method proceeds to step 570. If no, the method proceeds to step 560, and checks whether the total number M of rate hypotheses has been tested. If no, m′ is incremented at step 565, and the method returns to step 550.

At step 570, the method further verifies whether the recovered information bits b′ₙ[Rm] for sub-segment n are identical to the recovered information bits b′ₙ₋₁[Rm] for sub-segment n−1, for the tested rate hypothesis m′. If yes, this may be a further indication that the tested rate hypothesis m′ is indeed the correct rate hypothesis, and the method proceeds to step 580, wherein the detected rate R′ is declared as Rm′, and the recovered information bits are declared as b′ₙ[Rm′]. If no, the method may proceed to step 560.

If all rate hypotheses have been tested and the conditions of step 550 and 570 are not met, then rate detection may be declared not successful at step 561. Upon reaching step 561, the method may utilize alternative criteria not shown (e.g., a rate determination from a previous sub-segment or frame) to make a best estimate of the rate and the recovered bits.

In alternative exemplary embodiments (not shown), the information bits and/or FQI result and/or other metric results (such as the energy metric) for a sub-segment n may be compared at steps 550 and 570 to the corresponding metrics of sub-segments other than sub-segment (n−1), e.g., sub-segment (n−a), wherein a is a positive integer greater than 1. This increases the separation between the sub-segments used by algorithm 500, which may also improve the accuracy of the rate determination, as symbols lying in further separated sub-segments may generally be less correlated with each other.

One of ordinary skill in the art will also appreciate that for simplicity, alternative exemplary embodiments (not shown) may omit either of step 550 or step 570 from the method 500.

FIG. 5A depicts an alternative exemplary embodiment 500A of a rate detection algorithm that utilizes alternative rate decision metrics. Note steps in the method 500A and similarly numbered steps in the method 500 may have identical functionality, unless otherwise noted.

In FIG. 5A, at step 510, the method further inputs alternative parameters OtherMetric[R1] through OtherMetric[RM] to the rate detection algorithm. These alternative parameters may include, e.g., a zero-state metric of the decoding operation performed at step 420 of method 400, or an energy metric of the decoded sequence y′ₙ also obtained from the decoding performed at step 420.

Method 500A proceeds identically to method 500 until step 550A. At step 550A, the method checks whether a function F{ } of OtherMetricₙ[Rm′] is TRUE, and also whether the function F{ } of OtherMetricₙ₋₁[Rm′] is TRUE. For example, in an exemplary embodiment, the function F{ } may have the following expression (Function 1):

F{OtherMetricₙ[Rm′]}=(OtherMetricₙ[Rm′]>?Threshold1);

wherein Threshold1 is a predetermined threshold. For example, OtherMetricₙ[Rm′] may be an energy metric corresponding to the recovered information bits b′ₙ[Rm′] for sub-segment n and rate hypothesis Rm′, in which case F{ } returns TRUE if the energy metric is greater than the predetermined threshold Threshold1. One of ordinary skill in the art will appreciate that F{ } may generally correspond to any arbitrary function applied to a parameter OtherMetric.

FIG. 6 depicts an alternative exemplary embodiment 600 of a low-latency blind rate detection method according to the present disclosure. Note steps in the method 600 and similarly numbered steps in the method 400 may have identical functionality, unless otherwise noted.

In FIG. 6, method 600 proceeds identically to method 400 until step 610, after step 410. At step 610, the deinterleaved symbols y′ₙ for the n-th sub-segment are accumulated/combined with the deinterleaved symbols y′₁ through y′ₙ₋₁ from all previous sub-segments of the frame to generate the accumulated deinterleaved symbol sequence y′_{Σn}. Method 600 proceeds identically to method 400 for all steps subsequent to step 610, with the per-sub-segment symbols y′ₙ replaced by the accumulated symbols y′_{Σn} for all subsequent steps.

One of ordinary skill in the art will appreciate that the accumulated deinterleaved symbol sequence y′_{Σn} may include information from all symbols that have been received up to sub-segment n. In an exemplary embodiment, the rate detection algorithm 650 may utilize the same principles disclosed with reference to the rate detection algorithms described in FIGS. 5 and 5A.

In an alternative exemplary embodiment (not shown), an accumulated deinterleaved symbol sequence y′_{Σn} need not include information from all symbols that have been received up to sub-segment n, but may be modified to include information only from symbols received for sub-segment (n−a) to sub-segment n, wherein a is a positive integer. The candidate information bits, FQI result, and/or other metric results from such a modified deinterleaved symbol sequence may be compared to the corresponding information bits, FQI results, and/or other metric results determined from another such modified deinterleaved symbol sequence of the same frame, e.g., information from symbols received for sub-segment 1 to sub-segment a+1.

One of ordinary skill in the art will appreciate that in light of the description of FIG. 6, various other exemplary embodiments may readily be derived, and are within the scope of the present disclosure. For example, information bits and/or FQI results accumulated from sub-segments 1 through n may be compared to information bits and/or FQI results accumulated from sub-segments 1 through (n−1). Alternatively, results accumulated from sub-segments (n−b) through n may be compared to results accumulated from sub-segments (n−a−b) through (n−a), wherein b is a positive integer greater than or equal to 1.

In yet another exemplary embodiment, results from one set of (possibly multiple) sub-segments may be compared to two or more sets of (possibly multiple) sub-segments to determine the correct rate. For example, results accumulated from sub-segments 1 through n may be compared to results accumulated from sub-segments 1 through n+1, and both results may also be compared to results accumulated from sub-segments 1 through n+2, to determine the rate at sub-segment n+2.

One of ordinary skill will appreciate that various permutations of the accumulated or non-accumulated sub-segments may be compared, and that such alternative exemplary embodiments are contemplated to be within the scope of the present disclosure.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the exemplary embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the exemplary embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the exemplary embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other exemplary embodiments without departing from the spirit or scope of the invention. Thus, the present invention is not intended to be limited to the exemplary embodiments shown herein but is to be accorded the widest scope consistent with the principles and novel features disclosed herein.

1. A method for performing blind rate detection of a frame, the frame comprising a plurality of sub-segments, the method comprising:
deinterleaving symbols of a primary sub-segment of the frame;
for each of a plurality of rate hypotheses, recovering information bits based on symbols comprising the deinterleaved symbols of the primary sub-segment;
for each of the plurality of rate hypotheses, generating at least one quality metric based on symbols comprising the deinterleaved symbols of the primary sub-segment;
deinterleaving symbols of a secondary sub-segment of the frame;
for each of the plurality of rate hypotheses, recovering information bits based on symbols comprising the deinterleaved symbols of the secondary sub-segment;
for each of the plurality of rate hypotheses, generating at least one quality metric based on symbols comprising the deinterleaved symbols of the secondary sub-segment; and
based on the recovered information bits and quality metrics for the primary and secondary sub-segments, selecting a candidate rate hypothesis using a rate detection algorithm.

2. The method of claim 1, the at least one quality metric comprising a frame quality indicator (FQI), the rate detection algorithm comprising determining whether the FQI for the primary sub-segment and the FQI for the secondary sub-segment are both successes.

3. The method of claim 1, the rate detection algorithm comprising determining whether the recovered information bits for the primary sub-segment are identical to the recovered information bits for the secondary sub-segment.

4. The method of claim 2, the rate detection algorithm further comprising determining whether the recovered information bits for the primary sub-segment are identical to the recovered information bits for the secondary sub-segment.

5. The method of claim 1, the primary sub-segment being an eighth sub-segment of the frame, the secondary sub-segment being a sixteenth sub-segment of the frame.

6. The method of claim 1, the primary sub-segment being the first sub-segment of the frame, the secondary sub-segment being the second sub-segment of the frame

7. The method of claim 1, the symbols of the frame encoded according to the W-CDMA standard, the sub-segment of the frame comprising a slot.

8. The method of claim 1, the symbols of the frame encoded according to the cdma-2000 standard, the sub-segment of the frame comprising a power control group (PCG).

9. The method of claim 1, the recovering information bits comprising decoding deinterleaved symbols.

10. The method of claim 2, the frame quality indicator comprising a cyclical redundancy check (CRC).

11. The method of claim 1, further comprising:
deinterleaving symbols of a subsequent secondary sub-segment of the frame, the subsequent secondary sub-segment of the frame following the secondary sub-segment of the frame;
for each of the plurality of rate hypotheses, recovering information bits based on symbols comprising the deinterleaved symbols of the subsequent secondary sub-segment;
for each of the plurality of rate hypotheses, generating at least one quality metric based on symbols comprising the deinterleaved symbols of the subsequent secondary sub-segment; the selecting a candidate rate hypothesis further being based on the recovered information bits and quality metrics for the subsequent secondary sub-segment.

12. The method of claim 1, the symbols comprising the deinterleaved symbols of the primary sub-segment further comprising deinterleaved symbols of at least one sub-segment prior to the primary sub-segment, the symbols comprising the deinterleaved symbols of the secondary sub-segment further comprising deinterleaved symbols of at least one sub-segment prior to the secondary sub-segment.

13. The method of claim 12, the symbols comprising the deinterleaved symbols of the primary sub-segment further comprising deinterleaved symbols of all sub-segments prior to the primary sub-segment, the symbols comprising the deinterleaved symbols of the secondary sub-segment further comprising deinterleaved symbols of all sub-segments prior to the secondary sub-segment.

14. An apparatus for performing blind rate detection of a frame, the frame comprising a plurality of sub-segments, the apparatus comprising:
a deinterleaver configured to deinterleave symbols of a primary sub-segment and a secondary sub-segment of the frame;
a decoding module configured to, for each of a plurality of rate hypotheses, recover information bits based on symbols comprising the deinterleaved symbols of the primary sub-segment, and to recover information bits based on symbols comprising the deinterleaved symbols of the secondary sub-segment;
a quality metric generator configured to, for each of a plurality of rate hypotheses, generate at least one quality metric based on symbols comprising the deinterleaved symbols of the primary sub-segment, and to generate at least one quality metric based on symbols comprising the deinterleaved symbols of the secondary sub-segment; and
a rate detection module configured to, based on the recovered information bits and quality metrics for the primary and secondary sub-segments, select a candidate rate hypothesis using a rate detection algorithm.

15. The apparatus of claim 14, the at least one quality metric comprising a frame quality indicator (FQI), the rate detection algorithm comprising determining whether the FQI for the primary sub-segment and the FQI for the secondary sub-segment are both successes.

16. The apparatus of claim 14, the rate detection algorithm comprising determining whether the recovered information bits for the primary sub-segment are identical to the recovered information bits for the secondary sub-segment.

17. The apparatus of claim 14, the symbols of the frame encoded according to the W-CDMA standard, the sub-segment of the frame comprising a slot.

18. The apparatus of claim 14, the symbols of the frame encoded according to the cdma-2000 standard, the sub-segment of the frame comprising a power control group (PCG).

19. The apparatus of claim 15, the frame quality indicator comprising a cyclical redundancy check (CRC).

20. The apparatus of claim 14:
the deinterleaver further configured to deinterleave symbols of a subsequent secondary sub-segment of the frame, the subsequent secondary sub-segment of the frame following the secondary sub-segment of the frame;
the decoding module further configured to, for each of a plurality of rate hypotheses, recover information bits based on symbols comprising the deinterleaved symbols of the subsequent secondary sub-segment;
the quality metric generator further configured to, for each of a plurality of rate hypotheses, generate at least one quality metric based on symbols comprising the deinterleaved symbols of the subsequent secondary sub-segment; and
the rate detection module further configured to select the candidate rate hypothesis based on the recovered information bits and quality metrics for the subsequent secondary sub-segments.

21. The apparatus of claim 14, the symbols comprising the deinterleaved symbols of the primary sub-segment further comprising deinterleaved symbols of at least one sub-segment prior to the primary sub-segment, the symbols comprising the deinterleaved symbols of the secondary sub-segment further comprising deinterleaved symbols of at least one sub-segment prior to the secondary sub-segment.

22. The apparatus of claim 21, the symbols comprising the deinterleaved symbols of the primary sub-segment further comprising deinterleaved symbols of all sub-segments prior to the primary sub-segment, the symbols comprising the deinterleaved symbols of the secondary sub-segment further comprising deinterleaved symbols of all sub-segments prior to the secondary sub-segment.

23. An apparatus for performing blind rate detection of a frame, the frame comprising a plurality of sub-segments, the apparatus comprising:
means for deinterleaving symbols of a primary sub-segment and a secondary sub-segment of the frame;
means for recovering information bits based on symbols comprising the deinterleaved symbols of the primary sub-segment, and based on symbols comprising the deinterleaved symbols of the secondary sub-segment, for each of a plurality of rate hypotheses;
means for generating at least one quality metric based on symbols comprising the deinterleaved symbols of the primary sub-segment, and based on symbols comprising the deinterleaved symbols of the secondary sub-segment, for each of the plurality of rate hypotheses; and
means for selecting a candidate rate hypothesis using a rate detection algorithm.

24. The apparatus of claim 23, the symbols comprising the deinterleaved symbols of the primary sub-segment further comprising deinterleaved symbols of at least one sub-segment prior to the primary sub-segment, the symbols comprising the deinterleaved symbols of the secondary sub-segment further comprising deinterleaved symbols of at least one sub-segment prior to the secondary sub-segment.

25. The apparatus of claim 24, the symbols comprising the deinterleaved symbols of the primary sub-segment further comprising deinterleaved symbols of all sub-segments prior to the primary sub-segment, the symbols comprising the deinterleaved symbols of the secondary sub-segment further comprising deinterleaved symbols of all sub-segments prior to the secondary sub-segment.

26. A computer program product for performing blind rate detection of a frame, the frame comprising a plurality of sub-segments, the product comprising:
computer-readable medium comprising:
code for causing a computer to deinterleave symbols of a primary sub-segment and a secondary sub-segment of the frame;
code for causing a computer to recover information bits based on symbols comprising the deinterleaved symbols of the primary sub-segment, and based on symbols comprising the deinterleaved symbols of the secondary sub-segment, for each of a plurality of rate hypotheses;
code for causing a computer to generate at least one quality metric based on symbols comprising the deinterleaved symbols of the primary sub-segment, and based on symbols comprising the deinterleaved symbols of the secondary sub-segment, for each of the plurality of rate hypotheses; and
code for causing a computer to select a candidate rate hypothesis using a rate detection algorithm.

27. The computer program product of claim 26, the symbols comprising the deinterleaved symbols of the primary sub-segment further comprising deinterleaved symbols of at least one sub-segment prior to the primary sub-segment, the symbols comprising the deinterleaved symbols of the secondary sub-segment further comprising deinterleaved symbols of at least one sub-segment prior to the secondary sub-segment.

28. The computer program product of claim 26, the symbols comprising the deinterleaved symbols of the primary sub-segment further comprising deinterleaved symbols of all sub-segments prior to the primary sub-segment, the symbols comprising the deinterleaved symbols of the secondary sub-segment further comprising deinterleaved symbols of all sub-segments prior to the secondary sub-segment.
